(19) United States
(12) Patent Application Publication
(10) Pub. No.: US 2003/0009687 A1
(43) Pub. Date: Jan. 9, 2003

(54) Method and apparatus for validating integrity of software

(76) Inventors: Joerg U. Ferchau, Morgan Hill, CA (US); Jose A. Carreon, San Jose, CA (US); John C. Ahrens, Scotts Valley, CA (US); Michael J. McKay, Ben Lomond, CA (US)

Correspondence Address: SKJERVEN MORRILL LLP, 25 METRO DRIVE, SUITE 700, SAN JOSE, CA, 95110, US

(21) Appl. No.: 09/899,359

(22) Filed: Jul. 5, 2001

(51) Int. Cl. H04L 9/00

(52) U.S. Cl. 713/200; 713/176; 713/185

(57) ABSTRACT

A method for facilitating the integrity validation of data files includes providing a portable cryptographic device having a software verification key, and coupling the portable cryptographic device to a computing device. The method also includes identifying a target data file for validation on the computing device, and generating a software verification value for the target data file using the software verification key. An apparatus for facilitating the integrity validation of data files includes a software verification key that is provided on a portable cryptographic device. The apparatus also includes a security logic that is coupled to the software verification key. The security logic is operable to receive as input a target data file loaded on a computing device, and to generate a software verification value for the target data file using the software verification key.

### BACKGROUND

1. Field

The present invention relates generally to computer systems and, more particularly, to a method and apparatus for validating the integrity of data files.

2. Description of the Related Art

Large investments in the development and use of software have resulted in an ever-increasing dependence on computing devices in today's society. The software has enabled the computing devices to be increasingly used to conduct valuable transactions, and to generate or access sensitive, private, personal, or business information. This makes the computing devices attractive targets for sabotage, espionage, cyber-crime, hacking, or other malicious behavior intended to cause operational problems, to create security problems, or for criminal activities.

As the use of computing devices to perform critical business transactions and activities proliferates, the computing devices are increasingly becoming the subjects of unwanted attacks. A common method for attacking the computing devices is to compromise the integrity (e.g., by modifying or substituting) the operating system and/or application software that enable the computing device to correctly function.

One method is for an attacker to secretly substitute existing software with modified software designed to compromise confidential data and information on the computing device. The modified software may perform the functions of the prior, replaced software, while secretly (e.g., as a background process) compromising confidential data and information. For example, the modified software may compromise confidential and sensitive information, such as, by way of example, a credit card number, a password, etc. The modified software can transmit this compromised information to another computer over a network, where it is subsequently used to conduct unauthorized business transactions. Because the modified software is likely to perform the functions of the replaced software while secretly compromising the data, a user is likely to remain unaware of the damage being done.

Another method for compromising the integrity of the software is by a computer virus. A virus can be introduced into a computing device through mechanisms, such as, by way of example, a floppy drive coupled to the computing device, a network connection, a modem connection, and the like. The virus typically infects the computing device by attaching itself to one or more programs. When the user subsequently executes the affected program, confidential data and/or information on the computing device may be compromised and/or destroyed.

One common method of checking software integrity is to execute a virus checking software program on the computing device. The problem with this method is that they depend on the characteristics of the virus to detect the virus' presence, and, thus, a new virus with new characteristics may not be detectable by the virus checking software program. Additionally, because the virus checking software program is software-based, the virus checking software program itself can be modified or overwritten (e.g., the virus checking software program is itself susceptible to attack).

Another method of checking software integrity involves the use of checksums. A checksum is a type of integrity assessment code that is based on the number of set bits in the software program. For example, a CRC checksum algorithm generates an integrity assessment code based on the number of set (i.e., “1”) bits in the software program. A checksum can be calculated when a software program is first installed (e.g., when a software program is known to be “good”), and stored, along with the checksum algorithm, on the computing device. Thereafter, the checksum can be periodically calculated, for example, before executing the software program, and compared to the previously stored checksum to ensure integrity of the software. Checksums may be adequate for detecting accidental modifications to the software program, but because of their simplicity, are not an adequate defense against a well designed virus or substitute software that is designed to result in the same checksum. Furthermore, because the checksum algorithm is software-based, the checksum algorithm is susceptible to attack.

There exists a need to protect the integrity of the software that has enabled computing devices to play an ever-increasing role in today's society. Current methods of verifying software integrity are themselves susceptible to being compromised. What is needed is a method for validating the integrity of software that is not susceptible to being compromised.

### SUMMARY

The present disclosure is directed to an apparatus and corresponding methods that detect unauthorized changes (e.g., modifications, substitutions, additions, deletions, etc.) to a data files, including software programs, such as, by way of example, operating system software and application software. The apparatus and methods may alert the authorized device user or administrator of unauthorized or improper changes to data files used in conjunction with computing devices, appliances, or other devices that utilize one or more data files.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein.

In one embodiment, a method for validating the integrity of a target data file loaded on a computing device includes: providing a portable cryptographic device having a software verification key, the portable cryptographic device being coupled to a computing device; identifying a target data file for validation on the computing device; and generating a software verification value for the target data file using the software verification key.

In another embodiment, an apparatus for validating integrity of a data file includes a software verification key being provided on a portable cryptographic device. The apparatus also includes a security logic that is coupled to the software verification key. The security logic is operable to receive as input a target data file loaded on a computing device, and to generate a software verification value for the target data file using the software verification key.

In still another embodiment, a computer-readable storage medium has stored thereon computer instructions that, when executed by a computing device, cause the computing device to: detect a status change in a data file, the data file being loaded on a computing device; request a software verification key, the software verification key being provided on a portable cryptographic device, the portable cryptographic device being coupled to the computing device; and request a software verification value calculation for the data file, the software verification value calculation comprises a mathematical manipulation of the data file using the software verification key.

These and other embodiments of the present invention will also become readily apparent to those skilled in the art from the following detailed description of the embodiments having reference to the attached figures, the invention not being limited to any particular embodiment(s) disclosed.

### BRIEF DESCRIPTION OF THE DRAWINGS

FIG. 1 is a diagram illustrating an environment in which a portable cryptographic device of the present invention may operate.

FIG. 1A is a diagram illustrating another environment in which a portable cryptographic device of the present invention may operate.

FIG. 2 is a representation of one embodiment of an exemplary portable cryptographic device.

FIG. 3 illustrates a flow chart of an exemplary method by which a portable cryptographic device is used to generate a software verification value, according to one embodiment.

FIG. 4 illustrates a flow chart of an exemplary method by which a portable cryptographic device is used to verify software integrity, according to one embodiment.

### DETAILED DESCRIPTION

A portable cryptographic apparatus and corresponding methods, according to one embodiment, facilitates the detection of unauthorized or improper changes to data files, including software (e.g., operating system software, application software, etc.), used in conjunction with computing devices, appliances, or other devices that require or use one or more data files. An authorized device user or administrator is notified of any breach (e.g., unauthorized modification, substitution, addition, etc.) to a data file loaded and/or stored on the computing device. “Loaded,” “stored,” and variants thereof are used interchangeably herein. Also, “data file,” “software program,” and “software” are used interchangeably herein.

In one embodiment, a portable cryptographic device includes secret user information. The secret user information is used to authenticate a user as a valid, authorized user of the portable cryptographic device. The portable cryptographic device is then used to verify the integrity of one or more data files loaded on a computing device.

In one embodiment, a portable cryptographic device includes security logic that authenticates a user and subsequently generates a software verification value for a data file loaded on a computing device using a software verification key maintained on the portable cryptographic device. The security logic can execute on the portable cryptographic device and the software verification value is stored on the computing device. Alternatively, the software verification value can be stored on the portable cryptographic device, or a remote storage device coupled to, for example, the portable cryptographic device. In another embodiment, a security program executes on a computing device and generates a software verification value for a data file loaded on the computing device using the software verification key maintained on the portable cryptographic device.

In one embodiment, a portable cryptographic device includes security logic that verifies the integrity of a data file loaded on a computing device. The security logic authenticates a user and subsequently generates a software verification value for the data file using a software verification key maintained on the portable cryptographic device. The security logic then retrieves a previously generated software verification value from, for example, the computing device, portable cryptographic device, or a remote storage device (e.g., a networked server, etc.). The security logic verifies the integrity of the data file by comparing the retrieved software verification value with the generated software verification value.

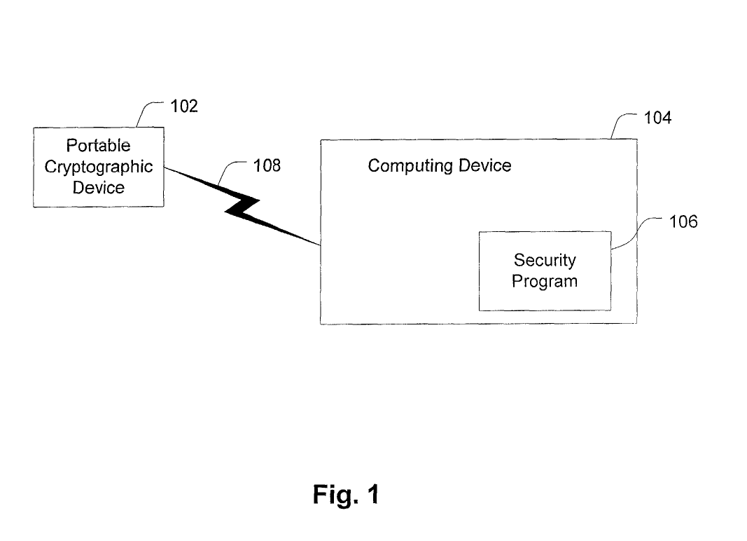

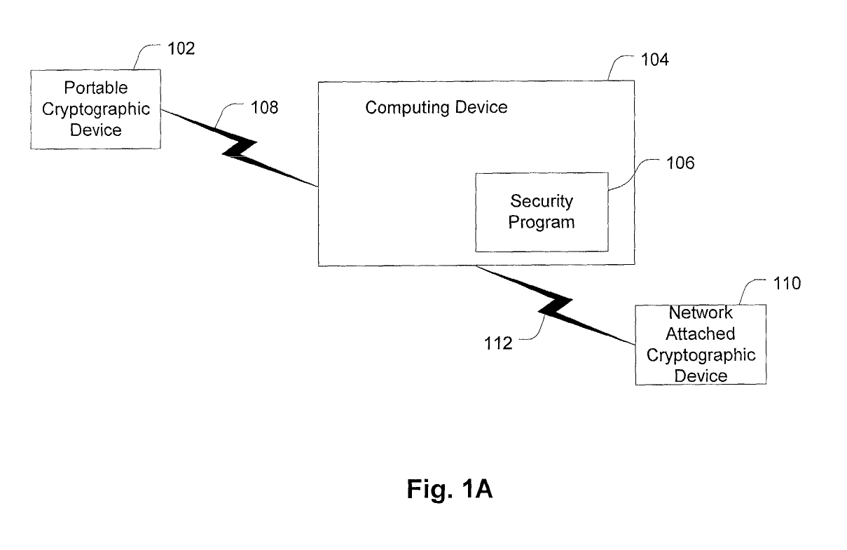

In another embodiment, a security program executes on a computing device and interacts with a portable cryptographic device coupled to the computing device. The security program requests identification information from a user. The security program authenticates the user by comparing the user input identification information with the secret user information on the portable cryptographic device. The security program generates a software verification value for a data file using a software verification key maintained on the portable cryptographic device. The security program then retrieves a previously generated software verification value and verifies the integrity of the data file by comparing the retrieved software verification value with the generated software verification value. Embodiments of the present invention are understood by referring to FIGS. 1-4 of the drawings. Throughout the drawings, components that correspond to components shown in previous figures are indicated using the same reference numbers.

Nomenclature

The detailed description that follows is presented largely in terms of processes and symbolic representations of operations performed by conventional computers, including computer components. A computer (e.g., computing device, appliance, devices that require software) may be any microprocessor or processor (hereinafter referred to as processor) controlled device such as, by way of example, personal computers, workstations, servers, clients, mini-computers, main-frame computers, laptop computers, a network of one or more computers, mobile computers, portable computers, handheld computers, palm top computers, set top boxes for a TV, interactive televisions, interactive kiosks, personal digital assistants, interactive wireless devices, mobile browsers, smart cards, magnetic striped cards, or any combination thereof. The computer may possess input devices such as, by way of example, a keyboard, a keypad, a mouse, a microphone, or a touch screen, and output devices such as a computer screen, printer, or a speaker. Additionally, the computer includes memory such as a memory storage device or an addressable storage medium.

The computer may be a uniprocessor or multiprocessor machine. Additionally the computer, and the computer memory, may advantageously contain program logic or other substrate configuration representing data and instructions, which cause the computer to operate in a specific and predefined manner as, described herein. The program logic may advantageously be implemented as one or more modules. The modules may advantageously be configured to reside on the computer memory and execute on the one or more processors. The modules include, but are not limited to, software or hardware components that perform certain tasks. Thus, a module may include, by way of example, components, such as, software components, processes, functions, subroutines, procedures, attributes, class components, task components, object-oriented software components, segments of program code, drivers, firmware, micro-code, circuitry, data, and the like.

The program logic conventionally includes the manipulation of data bits by the processor and the maintenance of these bits within data structures resident in one or more of the memory storage devices. Such data structures impose a physical organization upon the collection of data bits stored within computer memory and represent specific electrical or magnetic elements. These symbolic representations are the means used by those skilled in the art to effectively convey teachings and discoveries to others skilled in the art.

The program logic is generally considered to be a sequence of computer-executed steps. These steps generally require manipulations of physical quantities. Usually, although not necessarily, these quantities take the form of electrical, magnetic, or optical signals capable of being stored, transferred, combined, compared, or otherwise manipulated. It is conventional for those skilled in the art to refer to these signals as bits, values, elements, symbols, characters, text, terms, numbers, records, files, or the like. It should be kept in mind, however, that these and some other terms should be associated with appropriate physical quantities for computer operations, and that these terms are merely conventional labels applied to physical quantities that exist within and during operation of the computer.

It should be understood that manipulations within the computer are often referred to in terms of adding, comparing, moving, searching, or the like, which are often associated with manual operations performed by a human operator. It is to be understood that no involvement of the human operator may be necessary, or even desirable. The operations described herein are machine operations performed in conjunction with the human operator or user that interacts with the computer or computers.

It should also be understood that the programs, modules, processes, methods, and the like, described herein are but an exemplary implementation and are not related, or limited, to any particular computer, apparatus, or computer language. Rather, various types of general purpose computing machines or devices may be used with programs constructed in accordance with the teachings described herein. Similarly, it may prove advantageous to construct a specialized apparatus to perform the method steps described herein by way of dedicated computer systems with hard-wired logic or programs stored in non-volatile memory, such as, by way of example, read-only memory (ROM).

Overview

Referring now to the drawings, FIG. 1 illustrates an environment in which a portable cryptographic device 102 according to one embodiment may operate. As depicted, the environment includes portable cryptographic device 102 coupled to a computing device 104 through a connection 108. Computing device 104 includes a security program 106. In one embodiment, portable cryptographic device 102 interacts and communicates with security program 106 through connection 108 to provide secure integrity validation of one or more data files on computing device 104. As used herein, the terms “connected,” “coupled,” or any variant thereof, means any connection or coupling, either direct or indirect, between two or more elements; the coupling or connection between the elements can be physical, logical, or a combination thereof.

Portable cryptographic device 102 is a hardware device, such as, by way of example, a USB connected module, a smart card, integrated circuit components, or other portable storage device, capable of connecting to computing device 104. Portable cryptographic device 102 stores and provides a unique encryption key or data that is used to calculate the software verification value or other value used to validate the integrity of one or more data files loaded on computing device 104 as described herein.

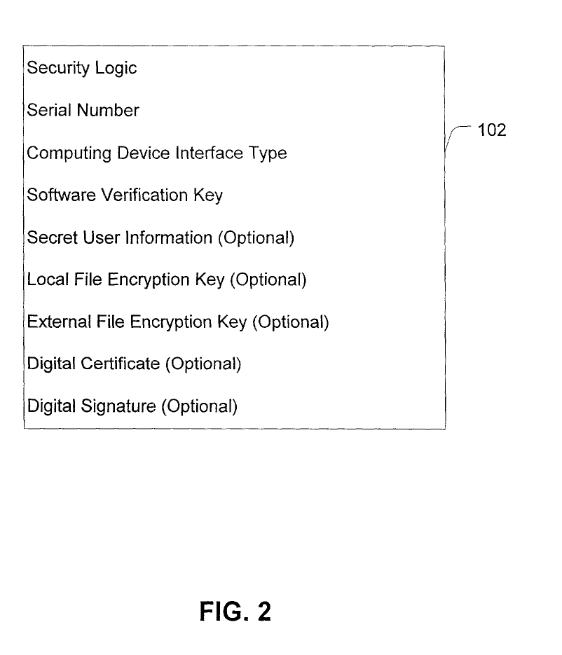

Portable cryptographic device 102 may optionally store and provide additional information used to provide additional security measures. The additional information may include, for example, user authentication information, one or more encryption keys, one or more digital certificates and/or digital signatures, and one or more software verification values. For example, the user authentication information may be used to authenticate a user of portable cryptographic device 102. The encryption key may be used to encrypt one or more files or data on computing device 104, and the digital certificate and/or digital signature may be used to verify that the user of one or more functions provided by portable cryptographic device 102 is who the user claims to be. Portable cryptographic device 102 is further discussed below in conjunction with FIG. 2.

Computing device 104 is a device, such as a computer, that facilitates the execution of one or more data files. Generally, computing device 104 functions to provide an environment that supports the storage and execution of one or more data files. As depicted in FIG. 1, computing device 104 includes security program 106. Security program 106 executes on computing device 104 and contains program logic to communicate with a coupled portable cryptographic device 102 through connection 108 to facilitate the software verification and other security functions.

In one embodiment, security program 106 contains program logic to perform the validation and security Functions as described herein. Security program 106 executing on computing device 104 performs the majority of the validation and security functions, and portable cryptographic device 102 generally functions as a repository for one or more keys and other information utilized by security program 106. Security program 106 may retrieve information provided on portable cryptographic device 102 as necessary to provide the validation and security functions.

For example, security program 106 may detect a change in status of a data file loaded on computing device 104. Assuming a status change in a data file, security program 106 may retrieve an appropriate key from the coupled portable cryptographic device 102 and use the retrieved key to generate a software verification value for the data file. As another example, security program 106 may provide data encryption capability. Security program 106 may provide an interface (e.g., an application interface, user interface, etc.) through which a user can request the offered data encryption services. If the user requests a data encryption service, security program 106 may retrieve an appropriate key from the coupled portable cryptographic device 102 and use the retrieved key to encrypt the user specified data. In similar fashion, security program 106 may offer and provide the other verification and security features.

In another embodiment, security program 106 contains program logic to provide ancillary functions that enable portable cryptographic device 102 to perform the validation and security functions as described herein. Portable cryptographic device 102 includes program logic to perform the majority of the validation and security functions. Portable cryptographic device 102 provides an operating environment that supports execution of the program logic included on portable cryptographic device 102, and majority of the validation and security functions are performed on portable cryptographic device 102.

For example, security program 106 may detect a change in status of a data file loaded on computing device 104. Assuming a status change in a data file, security program 106 may then initiate a request for portable cryptographic device 102 to generate a software verification value for the data file. Security program 106 may transmit or make available the data file to portable cryptographic device 102, enabling portable cryptographic device 102 to generate the software verification value.

In another embodiment, security program 106 may be provided on portable cryptographic device 102. Portable cryptographic device 102 may provide an operating environment that supports the execution of security program 106. The software verification value calculation, comparison, and software validation are performed on portable cryptographic device 102.

Those of ordinary skill in the art will realize that the distribution of the program logic execution is a function of the processing capability of portable cryptographic device 102, and that the execution of the program logic that facilitates the validation and security functions may be distributed differently between portable cryptographic device 102 and security program 106 without detracting from the essence of the invention.

In one embodiment, security program 106 may be implemented on a memory device, such as a ROM, on computing device 104. Security program 106 may then execute on computing device 104 to detect when to provide and perform the software validation and security functions. In another embodiment, security program 106 may be implemented as part of an operating system executing on computing device 104. In still another embodiment, security program 106 may be implemented as an application program that executes, for example, as a background process on computing device 104.

In a further embodiment, security program 106 may be included in portable cryptographic device 102. Portable cryptographic device 102, for example, upon connection to computing device 104, downloads security program 106 onto computing device 104. The downloaded security program 106 executes on computing device 104 to facilitate the validation and security functions in conjunction with portable cryptographic device 102.

In one embodiment, security program 106 provides an interface through which a user can specify one or more data files to be validated. Security program 106 monitors the specified data files and appropriately provides the software integrity validation processing as described herein. Security program 106 does not validate the data files that are not specified by the user. Thus, security program 106 offers a user flexibility to select the data files on computing device 104 he or she deems important enough to be validated by security program 106.

In another embodiment, portable cryptographic device 102 may include a list of one or more data files that is to receive the requisite validation processing as described herein. The list of data files is included in portable cryptographic device 102 at the time portable cryptographic device 102 is generated or made. In this instance, portable cryptographic device 102 may be made for use on a select number of computing devices 104.

Connection 108 provides connectivity between portable cryptographic device 102 and computing device 104 and security program 106 component of computing device 104. More specifically, connection 108 provides a medium that facilitates the transfer of data and information (e.g., electronic content) between portable cryptographic device 102 and computing device 104. For example, connection 108 may be a physical connection, such as a USB connection, that provides one or more USB ports. Portable cryptographic device 102 may then be, for example, a key-shaped device that “plugs into” the provided USB port. As another example, connection 108 may be a physical connection to a card reader. Portable cryptographic device 102 may then be, for example, a smart card, magnetic stripped card, or other card-like device that inserts into the card reader. In another embodiment, connection 108 may include a wireless connection, a network connection, an infrared connection, etc.

In one embodiment, portable cryptographic device 102 is personalized for use by a user. The user becomes the rightful owner of portable cryptographic device 102. Portable cryptographic device 102 includes secret user information that is known by the user and that is used to authenticate the user before providing the validation and security functions. Thus, portable cryptographic device 102 works in conjunction with the user and computing device 104 to authenticate the user and to verify the integrity of the software loaded on computing device 104 to the authorized user. For example, the user may be required to provide user identification information that is used to authenticate the user as an authorized user of portable cryptographic device 102 before portable cryptographic device 102 or security program 106 performs the offered validation and security functions. User verification is further discussed below in conjunction with FIG. 1A.

In another embodiment, the user may only be required to connect an appropriate portable cryptographic device 102 to computing device 104. The user may request the offered validation and security functions without furnishing user identification information. To properly use the validation and security functions, the user needs to provide a portable cryptographic device 102 that includes the key or other information that was previously used to generate a software verification value.

For example, computing device 104 may require portable cryptographic device 102 to be connected before it begins operating. As part of the boot-up or power-up process, computing device 104 may check to determine if the proper portable cryptographic device 102 has been connected by generating a software verification value for the operating system using a key included in the coupled portable cryptographic device 102. The software verification value is checked against a previously generated software verification value to validate the operating system integrity before completing the power-up or boot-up process. Thus, if a different portable cryptographic device 102 (e.g., a portable cryptographic device 102 that is different from a portable cryptographic device 102 that was previously used to generate a software verification value) is provided, a different software verification value is generated and the integrity of the operating system is not validated.

FIG. 1A illustrates another environment in which a portable cryptographic device 102 according to another embodiment may operate. In addition to the components depicted in FIG. 1, the environment also includes a network attached cryptographic device 110 coupled to computing device 104 through a connection 112. In this embodiment, the encryption key on portable cryptographic device 102 is not revealed to computing device 104. Computing device 104 stores a data file and its associated software verification value. For example, the software verification value can be calculated using the encryption key provided on portable cryptographic device 102. The calculated software verification value can then be stored on computing device 104 with the data file.

When a data file loaded on computing device 104 requires verification, portable cryptographic device 102 exports the encryption key to network attached cryptographic device 110. In one embodiment, portable cryptographic device 102 exports the encryption key to network attached cryptographic device 110 in a secure manner utilizing, for example, shared symmetric keys, derived symmetric keys (e.g., ANSI X9.24, EMV), Diffie-Hellman key exchange, signed Diffe-Hellman key exchange, SSL protocol, IPSEC/IKE protocol (i.e., Virtual Private Network Standard), and the like. ANSI X9.24 includes the VISA DUKPT algorithm, and is a method for deriving symmetric keys. EMV stands for “EuroPay-Mastercard-Visa” and is an industry standard for smartcards. There is an EMV protocol for deriving symmetric keys. IPSEC/IKE are standards associated with “Virtual Private Networks,” and provide a mechanism for key-exchanges. IPSEC is an IETF standard and Working Group. IPSEC includes a number of different FRCs, including RFC 2411. IKE is an IETF standard (RFC 2409) associated with IPSEC.

Portable cryptographic device 102 can export the encryption key to network attached cryptographic device 110 through computing device 104. In another embodiments, portable cryptographic device 102 may contain functionality to communicate with network attached cryptographic device 110 independent of computing device 104, for example, through a wireless connection.

Security program 106 sends the data file and the corresponding software verification value over, for example, connection 112 to network attached cryptographic device 110. Network attached cryptographic device 110 computes a software verification value using the encryption key received from portable cryptographic device 110. The newly computed software verification value is compared to the software verification value received from security program 106. Network attached cryptographic device 110 sends the comparison results to security program 106, for example, over connection 112. Security program 106 then takes appropriate action depending on the received comparison results.

In one embodiment, portable cryptographic device 102 user is verified before portable cryptographic device 102 exports the encryption key to network attached cryptographic device 111D. For example, user verification can be one or more of the following: verification by portable cryptographic device 102, verification by network attached cryptographic device 110, verification by computing device 104, verification by a security server (e.g., a computer) on a network, verification by one or more biometric devices, and the like. User verification and secure communication may or may not be related. For example, when user verification and secure communication are related, portable cryptographic device 102 can be used to verify the user and provide network access services (e.g., IPSEC/IKE) as part of the secure communication between portable cryptographic device 102 and network attached cryptographic device 110.

Portable Cryptographic Device

FIG. 2 is a representation of one embodiment of an exemplary portable cryptographic device 102. As depicted, portable cryptographic device 102 comprises a security logic, a serial number, a computing device interface type, a software verification key, a secure user information, a local file encryption key, an external file encryption key, a digital certificate, and a digital signature. Furthermore, the secret user information, the local file encryption key, the external file encryption key, the digital certificate, and the digital signature are optional, and one or more of the aforementioned items may not be included in portable cryptographic device 102.

The security logic comprises the program logic that is included in portable cryptographic device 102. The security logic works in conjunction with security program 106 component of computing device 104 to facilitate the validation and security functions. In one embodiment, assuming portable cryptographic device 102 provides adequate processing capabilities (e.g., a smart card with a limited processor, USB key device with a processor, etc.), the security logic may perform a majority of the validation and security function execution. For example, the security logic may comprise program logic that determines a software verification value for a data file. If portable cryptographic device 102 has limited processing capabilities (e.g., a passive magnetic stripped card), the security logic may be a “thin layer” that services requests by computing device 104 to obtain the information and data provided on portable cryptographic device 102.

The serial number is a sequence of characters that uniquely identifies portable cryptographic device 102. Each portable cryptographic device 102 will have a unique serial number, and no two portable cryptographic devices 102 will have the same serial numbers. The computing device interface type identifies the type of portable cryptographic device 102. This information may be used to determine the type of connection 108 between portable cryptographic device 102 and computing device 104. For example, the computing device interface type may identify portable cryptographic device 102 as a USB connected module, a smart card, a magnetic stripped card, or other type of portable storage device.

The software verification key is information or data used to perform a mathematical manipulation of the electronic or digital data that represents a software module, software application, operating system, or any other data file loaded on computing device 104 to create a software verification value. The software verification key may, for example, be a secure hashing function, encryption key, or other value, that can be used to create a mathematically created digital fingerprint (i.e., software verification value) of a data file. For example, the security logic on portable cryptographic device 102 or security program 106 on computing device 104 may generate a software verification value for a data file by any of several methods, such as, secure hashing, encryption, authentication calculations, digital signatures, and the like, using the software verification key.

The secret user information is used to identify a user of portable cryptographic device 102 as an authorized user. The secret user information may include information, such as, by way of example, a password, a personal identification number (PIN), a biometric data, or other information capable of identifying an authorized user, rightful possessor or owner of portable cryptographic device 102. The secret user information may include one or more of the aforementioned types of identification information. Thus, depending on the input capabilities of computing device 104, a user may decide to input a particular type of identification information. For example, if computing device 104 supports the input of bio-metric data such as fingerprint data, then the user can input bio-metric data to identify him or herself as an authorized user. If, for example, computing device 104 provides a keyboard and not a fingerprint reader, then the user can input a password or PIN to identify him or herself.

Portable cryptographic device 102 may also provide input capabilities. For example, portable cryptographic device 102 may be a smart card with a bio-metric reader. Portable cryptographic device 102 may contain the secret user information of its user. Thus, portable cryptographic device 102 is able to appropriately identify its user.

The local file encryption key is used to encrypt a file on a computing device 104. In one embodiment, security program 106 may contain program logic to provide file encryption capability to a user. If the user requests encryption of one or more files on computing device 104, security program 106 can use the local file encryption key on portable cryptographic device 102 to encrypt the user specified files.

The external file encryption key is used to encrypt a file on a computing device 104 before transmission of the file to, for example, another computing device 104. Security program 106 may contain program logic to provide file encryption capability for files being transmitted outside computing device 104 to a user. In one embodiment, the external file encryption key is a symmetrical key that is included in one or more portable cryptographic devices 102.

For example, two portable cryptographic devices 102 having the same external file encryption key (symmetric key) may be created and distributed to two executives in a company. A first executive in possession of the first portable cryptographic device 102 may then request encryption of an email message before being sent to the second executive that has the second portable cryptographic device 102. Security program 106 can encrypt the email message using the external file encryption key on the first portable cryptographic device 102. The second executive may then request security program 106 executing on his or her computing device 104 to decrypt the received email message. Security program 106 can decrypt the encrypted email message using the external file encryption key on the second portable cryptographic device 102.

The digital certificate is typically used to associate a key pair (e.g., a private key and a public key in asymmetric cryptography) with a user who is a prospective signer. Basically, the digital certificate is an electronic record that lists, for example, a public key, and confirms that the prospective signer identified in the digital certificate holds the corresponding private key. Thus, the principal function of the digital certificate is to bind a key pair to a particular user or signer (e.g., the digital certificate is used to verify that a user sending a message is who he or she claims to be). In one embodiment, security program 106 may contain program logic to provide a user the capability to transmit or send the digital certificate to one or more other users.

The digital signature is a key used to generate a digital code that uniquely identifies a user. The digital code can then be attached to an electronically transmitted message to guarantee that a sender of an electronic message is who he or she claims to be. In one embodiment, security program 106 may contain program logic to provide digital signature capability to a user. If the user requests to digitally sign one or more files (e.g., messages, emails, etc.) on computing device 104, security program 106 can use the digital signature on portable cryptographic device 102 to generate the digital code.

Method for Validating Software Integrity

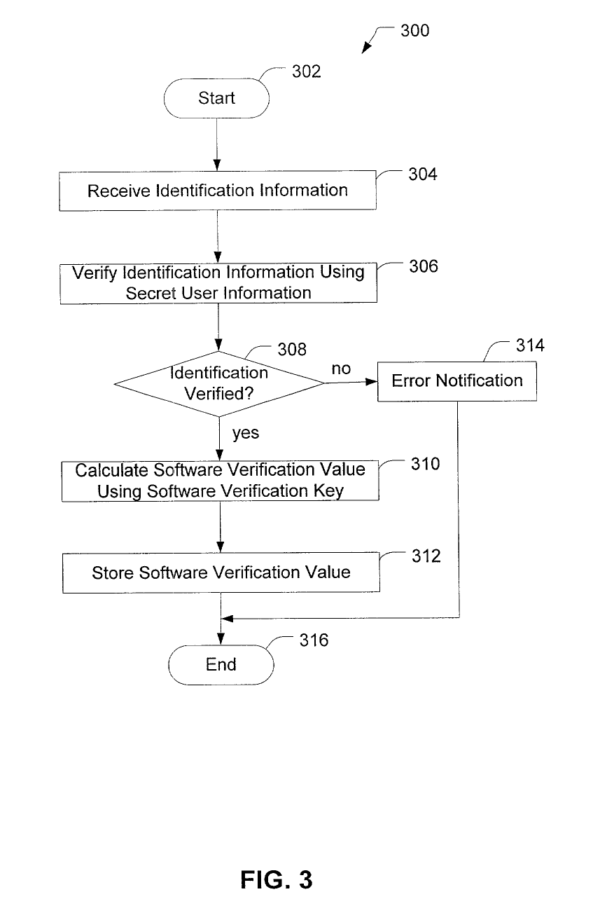

FIG. 3 illustrates a flow chart of an exemplary method 300 by which a portable cryptographic device 102 is used to generate a software verification value, according to one embodiment. Beginning at a start step 302, a user connects his or her portable cryptographic device 102 to his or her computing device 104. A security program 106 executes on computing device 104 and detects a need to generate a software verification value for a data file on computing device 104. For example, security program 106 may identify a need to calculate a software verification value for a data file when the data file is installed or stops executing (e.g., the data file closes), or when computing device 104 is being shut down.

At step 304, security program 106 requests and receives identification information from the user. For example, security program 106 may display a window requesting identification information, such as a password, PIN, or bio-metric data, from the user. The user can then input or supply the identification information through an appropriate input mechanism. At step 306, security program 106 verifies the identification information that was input by the user to authenticate the user as an authorized user of portable cryptographic device 102. In particular, security program 106 retrieves the secret user information provided on portable cryptographic device 102. At step 308, security program 106 compares the user provided identification information with the retrieved secret user information to verify the user identification.

If security program 106 does not identify the user as an authorized user (e.g., user provided identification information does not match any of the secret user information on portable cryptographic device 102), security program 106 generates and displays an error notification to the user at step 314. In one embodiment, security program 106 may perform additional actions, such as, by way of example, disable operation of portable cryptographic device 102, disable operation of computing device 104, and the like. Security program 106 then ends at step 316.

If, at step 308, security program 106 identifies the user as an authorized user, security program 106 retrieves the software verification key that is provided on portable cryptographic device 102 at step 310. Security program 106 uses the software verification key to generate a software verification value for the data file detected as needing the software verification value calculation (prior step 302). At step 312, security program 106 stores the generated software verification value. The software verification value is used to determine the integrity of the data file.

In one embodiment, the software verification value is stored or maintained on the on portable cryptographic device 102. In another embodiment, the software verification value is stored or maintained on computing device 104 or a component coupled to computing device 104. In one embodiment, assuming that an encryption key (i.e., local file encryption key or external file encryption key) is provided on portable cryptographic device 102, the security program can encrypt the software verification value using the encryption key. Having stored the software verification value, security program 106 ends at step 316.

Those of ordinary skill in the art will appreciate that, for this and other methods disclosed herein, the functions performed in the exemplary flow charts may be implemented in differing order. Furthermore, steps outlined in the flow charts are only exemplary, and some of the steps may be optional, combined into fewer steps, or expanded into additional steps without detracting from the essence of the invention. In other embodiments, some of the steps outlined in the flow charts may be performed, for example, by the security logic provided on portable cryptographic device 102.

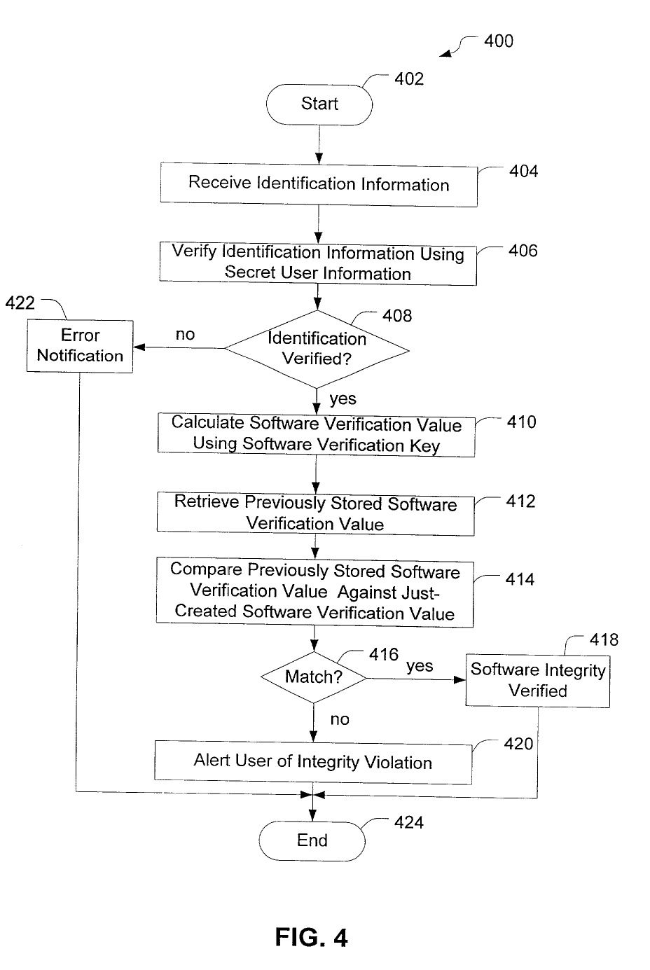

FIG. 4 illustrates a flow chart of an exemplary method 400 by which a portable cryptographic device 102 is used to verify software integrity, according to one embodiment. Beginning at a start step 402, a user connects his or her portable cryptographic device 102 to his or her computing device 104. A security program 106 executes on computing device 104 and detects a need to validate the integrity of a data file on computing device 104. For example, security program 106 may detect that a data file, such as, by way of example, the operating system or an application program, is about to start executing on computing device 104.

At step 404, security program 106 requests and receives identification information from the user through an appropriate input and output mechanism, such as, by way of example, a display device, a keyboard, a bio-metric reader, etc. that is connected to computing device 104. At step 406, security program 106 verifies the user provided identification information with the secret user information provided on portable cryptographic device 102. At step 408, security program 106 compares the user provided identification information with the retrieved secret user information to authenticate the user as an authorized user of portable cryptographic device 102.

If security program 106 does not identify the user as an authorized user, security program 106 generates and displays an error notification to the user at step 422. In one embodiment, security program 106 may perform additional actions, such as, by way of example, disable operation of portable cryptographic device 102, disable operation of computing device 104, and the like. Security program 106 then ends at step 424.

If, at step 408, security program 106 identifies the user as an authorized user, security program 106 retrieves the software verification key that is provided on portable cryptographic device 102 at step 410. Security program 106 uses the software verification key to generate a software verification value for the data file identified as needing the software verification validation (prior step 402). At step 412, security program 106 retrieves the previously generated and stored software verification value. The software verification value may have been stored and maintained on portable cryptographic device 102, computing device 104, or the component coupled computing device 104. If the previously generated software verification value is encrypted, security program 106 decrypts the previously generated software verification value using, for example, a key provided on portable cryptographic device 102.

At step 414, security program 106 compares the previously generated software verification value and the just-created software verification value, and determines if the two values match at step 416. If the two values do not match, security program 106 alerts the user, for example, by displaying a message, of the integrity violation at step 420 and ends at step 424. In one embodiment, security program 106 may provide the user an option to proceed with the data file execution. In another embodiment, security program 106 may perform additional actions, such as, by way of example, disable operation of portable cryptographic device 102, disable operation of computing device 104, disable execution of the data file, and the like.

If, at step 416, the previously generated software verification value and the just-created software verification value match, the security program validates the integrity of the data file at step 418. In particular, the data file continues to execute. Security program 106 ends at step 424.

Process Integrity

The following sections detail measures that can help ensure or provide additional integrity to the process as disclosed herein. These measures may provide additional integrity even in instances where an attacker obtains control of computing device 104 and has knowledge of the software validation method. In general, it is assumed that the attacker does not have possession of portable cryptographic device 102 or knowledge of the user verification information. In many cases, even if the attacker knows the user verification information, the attacker's lack of portable cryptographic device 102 allows for the integrity of the software.

Software Verification Value Generation

In one embodiment, two portable cryptographic devices provide for the integrity of data files. A first portable cryptographic device (Generate Software Verification Value Only Portable Cryptographic Device) is used whenever an authorized change or modification to a data file occurs. The Generate Software Verification Value Only Portable Cryptographic Device generates a software verification value for a data file and is likely maintained by a security administrator. A second portable cryptographic device (i.e., portable cryptographic device 102 as described herein) performs the software verification function. This second portable cryptographic device contains the software verification value generated by using the Generate Software Verification Value Only Portable Cryptographic Device.

For example, when a data file needs to be changed, the administrator can use the Generate Software Verification Value Only Portable Cryptographic Device, along with an appropriate security program (i.e., security program 106) or an option of the security program (i.e., an option of security program 106) to generate a software verification value for the data file. The software verification value, and information needed to associate the software verification value to the data file, are then loaded or stored on one or more portable cryptographic devices that can be used to verify the integrity of the data file. A user in possession of the portable cryptographic device can then verify the integrity of the data file. For example, the data file is passed to the portable cryptographic device, and the portable cryptographic device calculates a software verification value using a stored encryption key to calculate a software verification value. The portable cryptographic device then compares the two software verification values (i.e., the software verification value previously calculated by the Generate Software Verification Value Only Portable Cryptographic Device and the software verification value calculated by the portable cryptographic device) to validate the integrity of the data file.

In another embodiment, a single portable cryptographic device with control features on the option to generate a software verification value is used to validate the integrity of data files. For example, a portable cryptographic device can have multiple passwords. A first password on the portable cryptographic device entitles the user of the portable cryptographic device to generate a software verification value for a data file. The generated software verification value can be stored on the portable cryptographic device and subsequently used as a basis for validating the integrity of the data file. A second password on the portable cryptographic device entitles the user to use the portable cryptographic device to validate the integrity of the data file.

Software Verification Value Protection

Assuming a software verification value has been generated for each data file, the software verification values need to be stored to subsequently validate the integrity of the data file(s). In addition to the software verification value, additional information (e.g., filename associated with the software verification value, physical location of the file, etc.) needs to be stored for subsequent use during the validation process. There may be one or more files of software verification values and their associated data (software verification value file). In one embodiment, the software verification values and the associated data are stored on the portable cryptographic device.

Alternatively, for example, in instances where the portable cryptographic device does not have adequate storage capacity, the software verification value file can be stored on computing device 104. Computing device 104 may be susceptible to unwanted attacks, and thus, it may be desirable to protect the software verification value file (e.g., the software verification value file is another program/file that is stored on computing device 104) stored on computing device 104. In one embodiment, in addition to the filename and location data, the software verification value file may also store data on the data file such as size and date to further protect against unwanted and undesirable attacks to the data file. This additional information may be used to generate the software verification value.

In another embodiment, a software verification value for the software verification value file can be generated and stored on the portable cryptographic device. Here, the software verification value for the software verification value file needs to be checked and validated before a software verification value for a corresponding data file is recognized as valid.

As described herein, the present invention in at least one embodiment allows for the validation of the integrity of data files loaded on a computing device. In one embodiment, a user obtains a portable cryptographic device that contains one or more encryption keys, including a software verification key. The user then connects the portable cryptographic device to his or her computing device. A security program executes on the computing device and identifies a data file requiring integrity validation. The security program generates a software verification value using the software verification key provided on the portable cryptographic device and uses the software verification value to validate the integrity of the data file. Thus, the user can be assured that the data files loaded or executing on his or her computing device have not been tampered with or altered without the user's knowledge. This protects against attacks to the data files and removes the possibility of inadvertently executing a data file that may potentially cause damage to the data stored on the computing device.

In at least one embodiment, the present invention alerts a user to a modification to a data file since the last time the data file successfully executed on a computing device. A security program generates a software verification value when it detects that the data file is about to close or stop executing. The software verification value is generated using a software verification key provided on a portable cryptographic device that is connected to the computing device. The next time the data file starts executing, the security program generates a new software verification value. The security program then compares the two software verification values to ensure that the data file has not been altered or modified. The data file notifies the user if the two values do not match. Thus, the user is alerted and notified of any modifications to the data files on his or her computing device.

In at least one embodiment, the present invention enables a user to select the data files the user wants to have validated. A security program provides an interface through which the user can specify one or more data files. The security program, working in conjunction with a portable cryptographic device connected to a computing device, validates the integrity of the data files specified by the user. The other, non-specified data files are not validated by the security program. This allows the user to selectively choose the data files on his or her computing device that are important enough to have validated.

This invention may be provided in other specific forms and embodiments without departing from the essential characteristics as described herein. The embodiments described above are to be considered in all aspects as illustrative only and not restrictive in any manner. The following claims rather than the foregoing description indicate the scope of the invention.

What is claimed is:

1. A method for validating the integrity of a target data file loaded on a computing device, the method comprising:
providing a portable cryptographic device having a software verification key, the portable cryptographic device being coupled to a computing device;
identifying a target data file for validation on the computing device; and
generating a software verification value for the target data file using the software verification key.

2. The method of claim 1 further comprising storing the software verification value on the portable cryptographic device.

3. The method of claim 1 further comprising storing the software verification value on the computing device.

4. The method of claim 1 further comprising:
receiving a user identification; and
validating the user identification against a secret user information, wherein the secret user information is provided on the portable cryptographic device.

5. The method of claim 4, wherein the user identification comprises a password.

6. The method of claim 4, wherein the user identification comprises a personal identification number.

7. The method of claim 4, wherein the user identification comprises a biometric data.

8. The method of claim 1 further comprising:
requesting a previously generated software verification value; and
comparing the software verification value with the previously generated software verification value.

9. The method of claim 8, wherein comparing the software verification value is performed in response to a startup of the target data file.

10. The method of claim 1, wherein the portable cryptographic device is a smart card.

11. The method of claim 1, wherein the portable cryptographic device is a USB connected module.

12. The method of claim 1, wherein generating the software verification value comprises a secure hashing calculation.

13. The method of claim 1, wherein generating the software verification value comprises an encryption calculation.

14. The method of claim 1, wherein generating the software verification value comprises a message authentication calculation.

15. The method of claim 1, wherein generating the software verification value comprises a digital signature.

16. The method of claim 1, wherein the target data file comprises an operating system.

17. The method of claim 1, wherein the target data file comprises an application program.

18. The method of claim 1, wherein the software verification value is generated in response to detecting an install of the data file.

19. The method of claim 1, wherein the software verification value is generated in response to detecting a closing of the data file.

20. The method of claim 1, wherein the software verification value is generated in response to detecting a shutdown of the computing device.

21. The method of claim 1, wherein the generating the software verification value is performed by logic on the portable cryptographic device.

22. The method of claim 1, wherein the generating the software verification value is performed by logic executing on the portable cryptographic device.

23. The method of claim 1, wherein the generating the software verification value is performed by logic executing on the computing device.

24. An apparatus for validating integrity of a data file, the apparatus comprising:
a software verification key being provided on a portable cryptographic device; and
a security logic coupled to the software verification key, the security logic operable to receive as input a target data file loaded on a computing device, the security logic operable to generate a software verification value for the target data file using the software verification key.

25. The apparatus of claim 24, wherein the security logic executes on the portable cryptographic device.

26. The apparatus of claim 24, wherein the security logic executes on the computing device.

27. The apparatus of claim 24, wherein the portable cryptographic device is coupled to the computing device.

28. The apparatus of claim 24, wherein the security logic is further operable to store the software verification value on the computing device.

29. The apparatus of claim 28, wherein the software verification value is a protected software verification value.

30. The apparatus of claim 24, wherein the security logic is further operable to receive as input a user identification and validate the user identification against a secret user information, the secret user information being provided on the portable cryptographic device.

31. The apparatus of claim 24, wherein the security logic is further operable to request a previously generated software verification value and compare the software verification value against the previously generated software verification value.

32. A computer-readable storage medium having stored thereon computer instructions that, when executed by a computing device, cause the computing device to:
detect a status change in a data file, the data file being loaded on a computing device;
request a software verification key, the software verification key being provided on a portable cryptographic device, the portable cryptographic device being coupled to the computing device; and
request a software verification value calculation for the data file, the software verification value calculation comprises a mathematical manipulation of the data file using the software verification key.

33. The computer-readable storage medium of claim 32, wherein the software verification value calculation is performed on the computing device.

34. The computer-readable storage medium of claim 32, wherein the software verification value calculation is performed on the portable cryptographic device.

35. The computer-readable storage medium of claim 32, wherein the status change comprises an install of the data file.

36. The computer-readable storage medium of claim 32, wherein the status change comprises a closing of the data file.

37. The computer-readable storage medium of claim 32, wherein the status change comprises a shutdown of the computing device.

38. The computer-readable storage medium of claim 32, wherein the computer instructions that detect a status change in a data file further comprise computer instructions that, when executed by a computing device, cause the computing device to:
receive a user identification; and
validate the user identification against a secret user information, the secret user information being provided on the portable cryptographic device.

39. The computer-readable storage medium of claim 32, wherein the computer instructions that detect a status change in a data file further comprise computer instructions that, when executed by a computing device, cause the computing device to:
request a previously generated software verification value for the data file; and
compare the software verification value with the previously generated software verification value.

40. The computer-readable storage medium of claim 39, wherein the compare of the software verification value is performed in response to detecting a startup of the data file.
